(19) United States
(12) Patent Application Publication
(10) Pub. No.: US 2014/0168979 A1
(43) Pub. Date: Jun. 19, 2014

(54) LIGHT EMITTING DIODE MODULE WITH HEAT-CONDUCTING POLES

(71) Applicant: HON HAI PRECISION INDUSTRY CO., LTD., New Taipei (TW)

(72) Inventor: CHIH-CHEN LAI, New Taipei (TW)

(73) Assignee: HON HAI PRECISION INDUSTRY CO., LTD., New Taipei (TW)

(21) Appl. No.: 13/855,647

(22) Filed: Apr. 2, 2013

(30) Foreign Application Priority Data
Dec. 13, 2012 (TW) 101147114

(51) Int. Cl. F21V 29/00

(52) U.S. Cl. CPC F21V 29/2275
USPC 362/249.02

(57) ABSTRACT

An exemplary light-emitting diode (LED) module includes a base, a substrate arranged on the base, and LED chips mounted on the substrate. Through holes are defined in the substrate. The through holes are spaced from each other. Heat-conducting poles extend through the through holes, and a top end of each heat-conducting pole connects the LED chip and a bottom end of each heat-conducting pole connects the base. Heat generated from the LED chips is absorbed by the heat-conducting poles, and then transferred to the base for dissipation from the base.

### BACKGROUND

1. Technical Field

The present disclosure generally relates to light-emitting diode (LED) modules, and more particularly to an LED module with heat-conducting poles for high heat dissipation efficiency.

2. Description of Related Art

A conventional LED module includes a substrate, a circuit formed on the substrate, and a plurality of LEDs mounted on the substrate and electrically connecting with the circuit.

Due to the increased power of modern LEDs, a great amount of heat is generated by a typical LED module when working. If the heat can not be dissipated effectively, the LED module overheats, resulting in a poor luminous efficiency and poor reliability. Therefore, how to efficiently dissipate heat generated from LEDs has become an important topic of a general concern to the industry.

What is needed, therefore, is an improved LED module which can overcome the above-described shortcomings

### BRIEF DESCRIPTION OF THE DRAWINGS

FIG. 1 is a schematic view of part of an LED module according to an exemplary embodiment of the present disclosure.

FIG. 2 is a sectional view of part of the LED module of FIG. 1, taken along a line II-II thereof.

FIG. 3 is an exploded view of the LED module of FIG. 2.

### DETAILED DESCRIPTION

Embodiments of an LED module will now be described in detail below and with reference to the drawings.

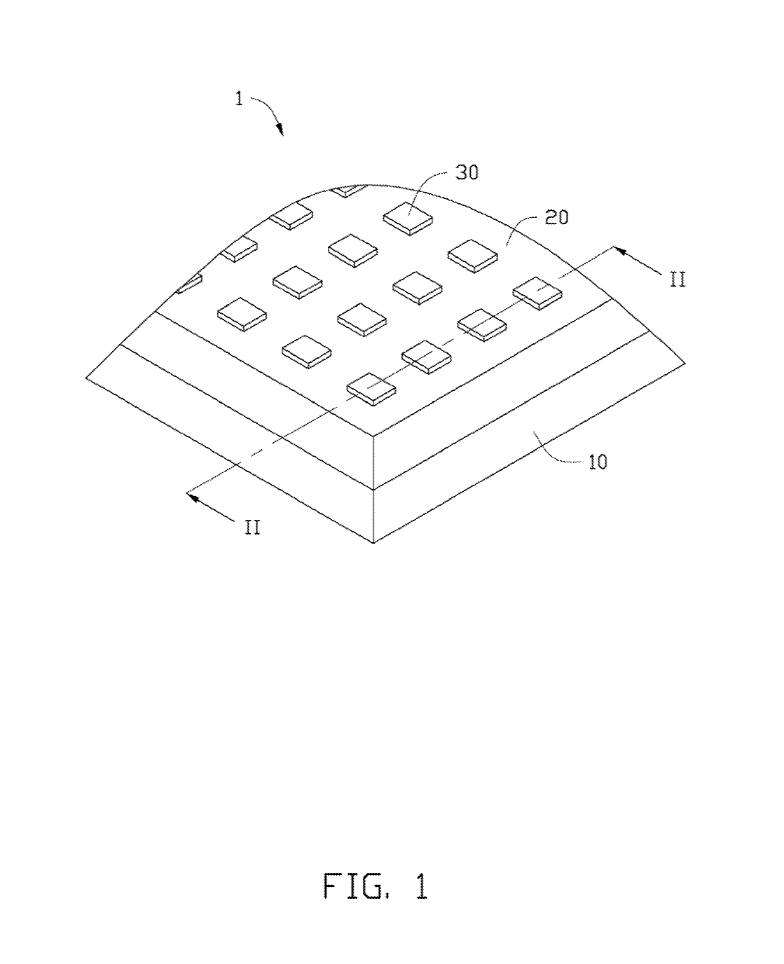

Referring to FIG. 1, an LED module 1 according to an exemplary embodiment of the present disclosure includes a base 10, a substrate 20 arranged on the base 10, and a plurality of LED chips 30 mounted on the substrate 20.

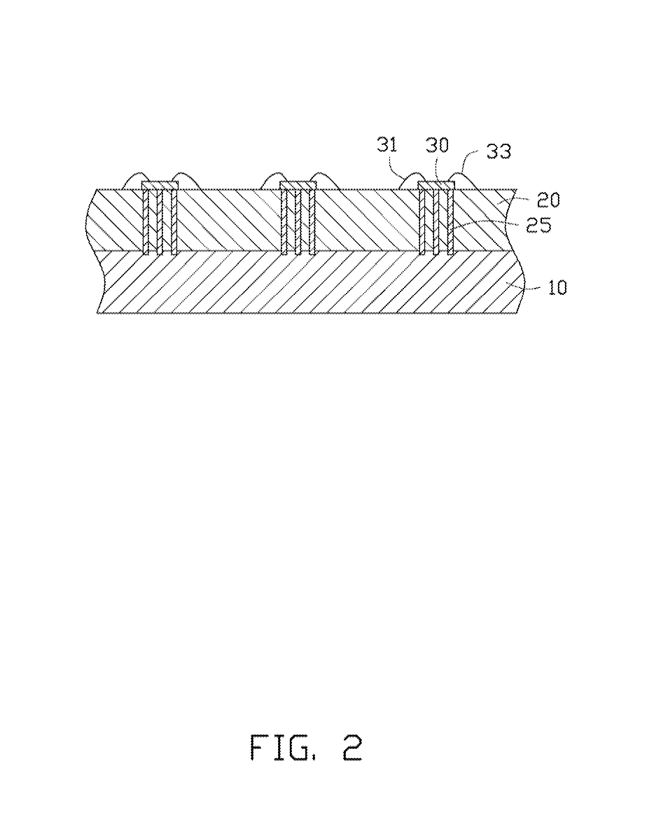

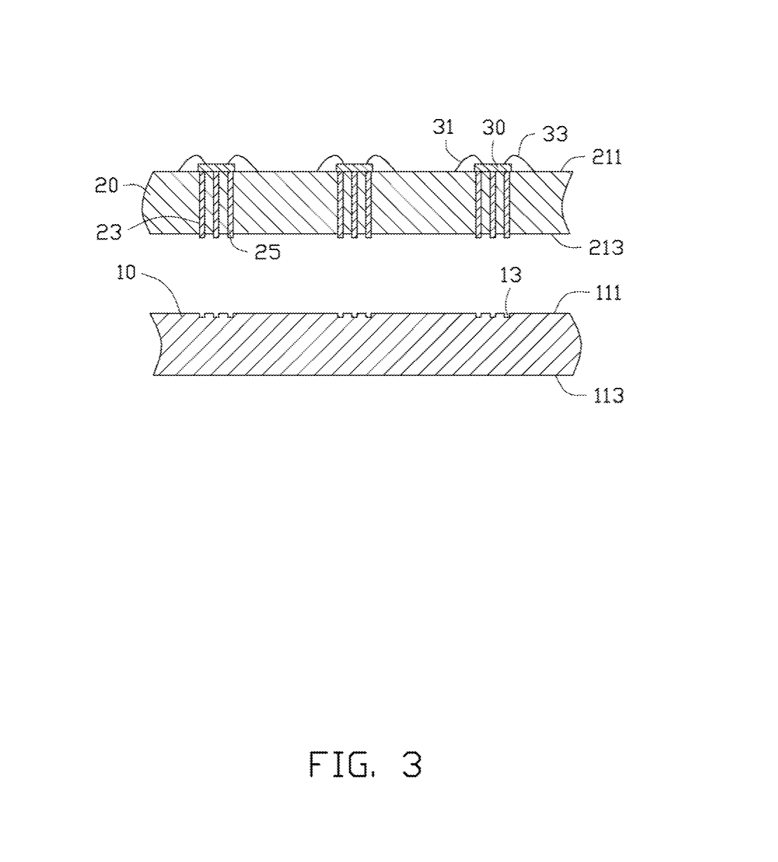

Referring also to FIGS. 2-3, the base 10 is flat. A plurality of receiving holes 13 is defined in a top end of the base 10. In this embodiment, the base 10 is made of material with a high thermal conductivity, such as metal or metal alloy. The base 10 includes a top surface 111 and a bottom surface 113 at an opposite sides thereof. The top surface 111 and the bottom surface 113 are flat and parallel to each other. The receiving holes 13 are spaced from each other.

Each receiving hole 13 is column-shaped. A vertical cross-section of the receiving hole 13 is rectangular.

The substrate 20 is a rectangular plate with a uniform thickness. The substrate 20 includes a top surface 211, and a bottom surface 213 opposite to the top surface 211. A circuit (not shown) is formed on the top surface 211 to electrically connect the LED chips 30.

A plurality of through holes 23 is defined in the substrate 20. The through holes 23 are spaced from each other, and each through hole 23 penetrates through the substrate 20 from the top surface 211 to the bottom surface 213. The through holes 23 are aligned with the receiving holes 13. In the embodiment, the substrate 20 is made of an insulating material with a lower thermal expansion coefficient, such as a phenolic.

A plurality of heat-conducting poles 25 extends through the through holes 23 of the substrate 20 and is inserted into the receiving holes 13 of the base 10. Each heat-conducting pole 25 may be a solid pole or a hollow pole, and completely fills the corresponding through hole 23. Preferably, a solid heat-conducting pole 25 is applied in this embodiment, due to its higher heat conductivity. A top end of the heat-conducting pole 25 is level with the top surface 211 of the substrate 20. A bottom end of the heat-conducting pole 25 extends beyond the bottom surface 213 of the substrate 20, and is received in the receiving hole 13 and firmly engaged with the base 10. For example, the bottom end of the heat-conducting pole 25 may be interferingly received in the receiving hole 13, to maximize surface contact between the heat-conducting pole 25 and the base 10. In this way, the substrate 20 and the base 10 are combined by the heat-conducting poles 25. Preferably, glue is applied between the top surface 111 of the base 10 and the bottom surface 213 of the substrate 20, to make the base 10 and the substrate 20 firmly combined.

In order to increase the contact area between the heat-conducting poles 25 and the base 10, a size of a horizontal cross-section of the bottom end of each heat-conducting pole 25 can be made bigger than that of other parts of the heat-conducting pole 25. For example, the size of the horizontal cross-section of the bottom end of each heat-conducting pole 25 can be slightly bigger than that of other parts of the heat-conducting pole 25. In this embodiment, each heat-conducting pole 25 is made of material with a high thermal conductivity, such as aluminum, copper or silver.

Each LED chip 30 is electrically connected to electrode structures of the circuit on the top surface 211 of the substrate 20 via wires 31, 33, and the LED chip 30 covers the top ends of the corresponding heat-conducting poles 25. In this embodiment, a bottom surface of the LED chip 30 is directly mounted on the top ends of the heat-conducting poles 25.

When the LED module 1 is used, heat generated from each of the LED chips 30 is absorbed by the corresponding heat-conducting poles 25, and then transferred to the base 10 rapidly for dissipation from the base 10.

Furthermore, because the heat-conducting poles 25 extend through the through holes 23 and the bottom ends of the heat-conducting poles 25 are inserted into the corresponding receiving holes 13 of the base 10, the total contact area between the base 10 and the heat-conducting poles 25 is increased. This facilitates the heat-dissipating efficiency of the LED module 1.

In addition, because the substrate 20 is made of material with a lower thermal expansion coefficient, this protects the substrate 20 and the LED chips 30 from being deformed when the substrate 20 absorbs heat from the LED chips 30.

Finally, since the heat-conducting poles 25 are spaced from each other, the stress between the substrate 20 and the heat-conducting poles 25 is dispersed, which protects the substrate 20 and the LED chips 30 from being deformed.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A light-emitting diode (LED) module comprising:
a base;
a substrate arranged on the base, the substrate comprising a top surface and a bottom surface at opposite sides thereof, the substrate having a plurality of through holes defined therein;
a plurality of LED chips mounted on the substrate; and
a plurality of heat-conducting poles extending through the through holes, top ends of the heat-conducting poles connecting the LED chips and bottom ends of the heat-conducting poles connecting the base, such that heat generated from the LED chips is absorbed by the heat-conducting poles and then transferred to the base for dissipation.

2. The LED module of claim 1, wherein the top end of each heat-conducting pole is level with the top surface of the substrate.

3. The LED module of claim 2, wherein the bottom end of each heat-conducting pole is extending beyond the bottom surface of the substrate.

4. The LED module of claim 3, wherein a plurality of receiving holes are defined in a top end of the base, each receiving hole is corresponding with a respective one of the heat-conducting poles, and each receiving hole receives each bottom end of the heat-conducting pole beyond the bottom surface of the substrate.

5. The LED module of claim 4, wherein a size of a horizontal cross-section of the bottom end of the heat-conducting poles is bigger than that of other parts of the heat-conducting poles.

6. The LED module of claim 4, wherein each heat-conducting pole is column-shaped, and a vertical cross-section of the heat-conducting pole is rectangular.

7. The LED module of claim 1, wherein the substrate is made of a phenolic.

8. The LED module of claim 7, wherein the base is made of metal or metal alloy.

9. The LED module of claim 1, wherein the heat-conducting pole is made of aluminum, copper or silver.

10. A light-emitting diode (LED) module comprising:
a substrate having a top surface and a bottom surface at opposite sides thereof;
a plurality of heat-conducting poles extending through the substrate from the top surface to the bottom surface; and
a plurality of LED chips mounted on the top surface of the substrate;
wherein a top end of each heat-conducting pole is level with the top surface of the substrate and contacts one of the plurality of LED chips.

11. The LED module of claim 10, wherein a bottom end of each heat-conducting pole is extending beyond the bottom surface of the substrate.

12. The LED module of claim 11, further comprising a base made of metal or metal alloy.

13. The LED module of claim 12, wherein the base defines a plurality of receiving holes corresponding with the bottom ends of the heat-conducting poles extending beyond the bottom surface of the substrate, and the receiving holes receive the bottom ends of the heat-conducting poles and engage the substrate firmly.

14. The LED module of claim 10, wherein the substrate is made of phenolics.

15. The LED module of claim 10, wherein the heat-conducting poles are made of copper, silver or aluminum.
